(19) United States
(12) Patent Application Publication
(10) Pub. No.: US 2019/0338943 A1
(43) Pub. Date: Nov. 7, 2019

(54) KEEPSAKE CANDLE AND METHODS OF MANUFACTURING SAME

(71) Applicant: Richard Francis Putnam, Manasquan, NJ (US)

(72) Inventor: Richard Francis Putnam, Manasquan, NJ (US)

(21) Appl. No.: 16/400,582

(22) Filed: May 1, 2019

Related U.S. Application Data
(60) Provisional application No. 62/664,969, filed on May 1, 2018.

(51) Int. Cl. F21V 35/00; C11C 5/00

(52) U.S. Cl. CPC F21V 35/00; C11C 5/006; C11C 5/002

(57) ABSTRACT

A novelty candle includes an elongated cylindrical durable glass body having a first height and a first diameter, the body having a first end and a second end and defining a concave well adjacent the first end, and a solid portion extending along at least half of the first height, a fuel source disposed within the well, the fuel source including a paraffin wax, a wick at least partially disposed within the fuel source, a murrini coupled to a bottom of the glass body adjacent the second end, and a glass base at least partially covering the murrini and forming a plurality of smooth curvatures with sides of the body.

### CROSS-REFERENCE TO RELATED APPLICATIONS

The present application claims the benefit of U.S. Provisional Patent Application No. 62/664,969, filed on May 1, 2018, the contents of which are hereby incorporated by reference in their entirety as if fully set forth herein.

### FIELD OF THE DISCLOSURE

The present disclosure relates to keepsake candles and methods of their manufacture. More particularly the present disclosure relates to candles having durable components that can be used to commemorate people, athletics, activities or events.

### BACKGROUND OF THE DISCLOSURE

Traditional candles typically include a wax body having an ignitable wick embedded therein. Candles are used to provide light, heat, and in some cases, a fragrance. Candles are also used in religious rituals, and celebrations, such as birthday celebrations, and other similar personal or communal rituals.

Birthday candles, for examples, are placed on top of a cake, typically symbolizing the age of the individual being celebrated. In some cultures, the “Happy Birthday” song is sung, and the celebrated individual blows out the candles while making a wish. The extinguished candles are then removed and the cake is served to the guests. Extinguished candles are typically discarded or lost.

### SUMMARY OF THE DISCLOSURE

In some embodiments, a novelty candle includes an elongated cylindrical durable glass body having a first height and a first diameter, the glass body having a first end and a second end and defining a concave well adjacent the first end, and a solid portion extending along at least half of the first height. The candle further includes a fuel source disposed within the well, the fuel source including a paraffin wax, a wick at least partially disposed within the fuel source, a murrini coupled to a bottom of the glass body adjacent the second end, and a glass base at least partially covering the murrini and forming a plurality of smooth curvatures with sides of the body.

In some embodiments, a method of manufacturing a novelty candle includes providing an elongated cylindrical durable glass body having a first height and a first diameter, the body having a first end and a second end, forming a concave well in the glass body adjacent the first end while maintaining a solid portion of the glass body that extends along at least half of the first height, disposing a fuel source within the well, the fuel source including a paraffin wax, at least partially disposing a wick within the fuel source, coupling a murrini to a bottom of the glass body adjacent the second end, and at least partially covering the murrini with a glass base to form a plurality of smooth curvatures with sides of the body.

### BRIEF DESCRIPTION OF THE DISCLOSURE

Various embodiments of the presently disclosed connectors are disclosed herein with reference to the drawings, wherein:

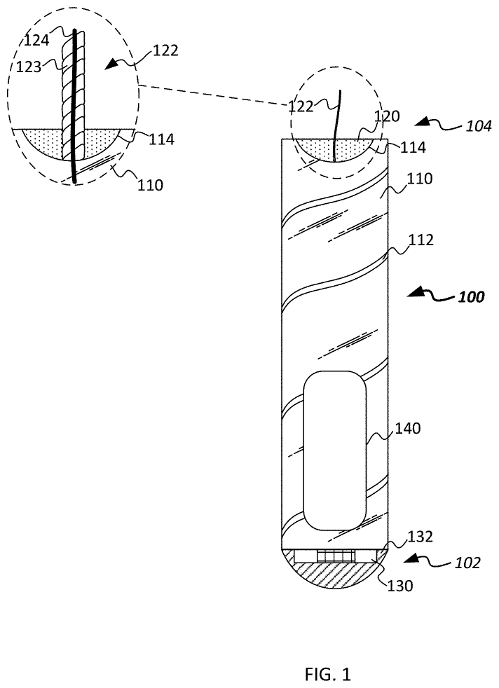

FIG. 1 is a schematic side view of a candle having a durable portion and a murrini according to one embodiment of the disclosure;

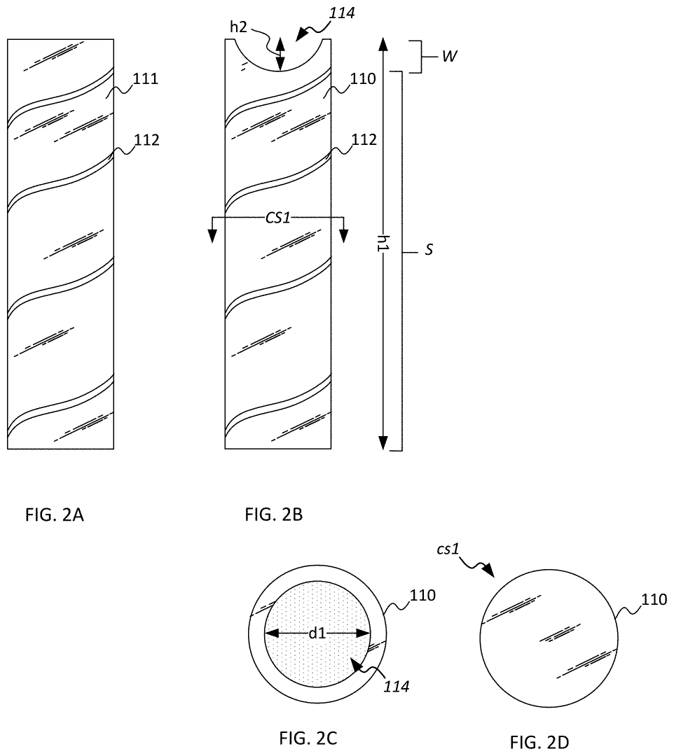

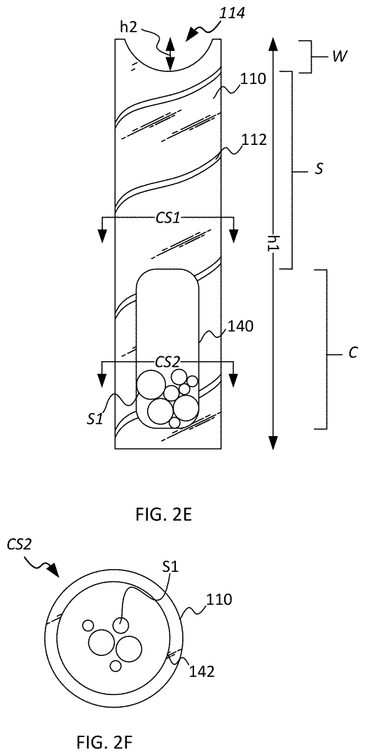

FIG. 2A is schematic side view of a glass cane for use with the candle of FIG. 1;

FIG. 2B is schematic side view of the glass body of FIG. 2A after a well has been formed therein;

FIG. 2C is a schematic top view of the glass body of FIG. 2B across the top of the well;

FIG. 2D is a schematic cross-sectional view of the glass body of FIG. 2B across a solid portion;

FIG. 2E is a schematic side view of a glass body having an optional compartment;

FIG. 2F is a schematic cross-sectional view of the glass body of FIG. 2E across the compartment;

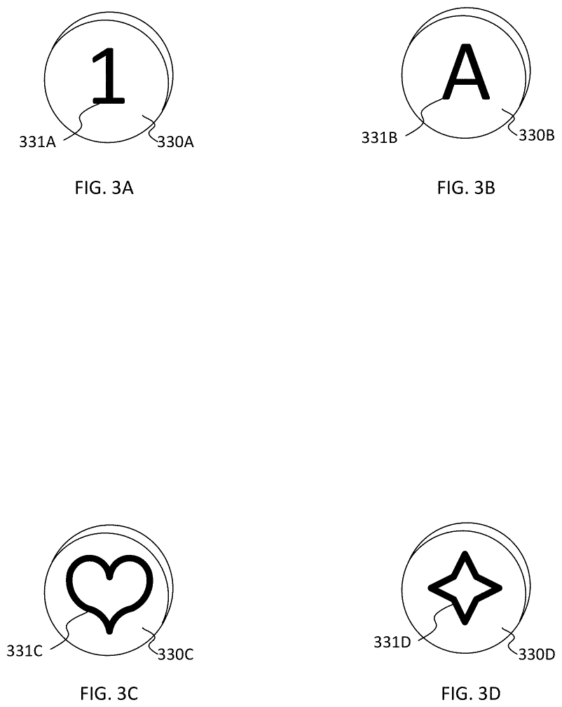

FIGS. 3A-D are schematic bottom views of several examples of murrini portions for use with the candle of FIG. 1; and

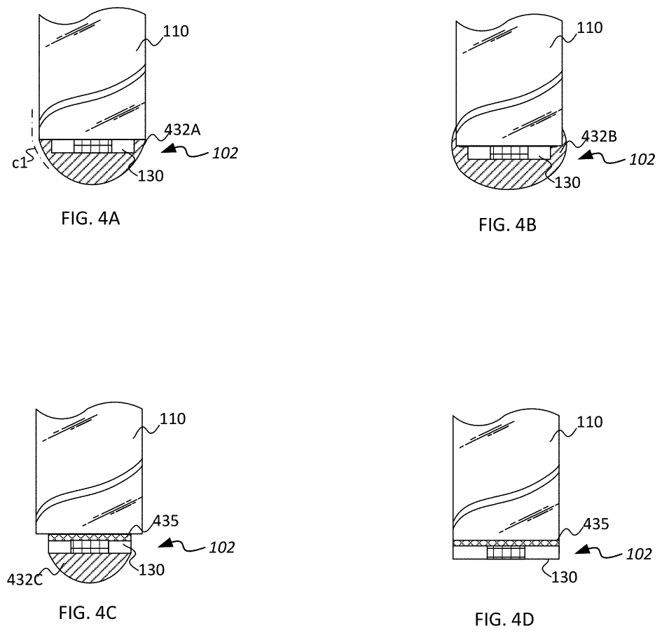

FIGS. 4A-D are schematic side views of several examples of a bottom of a candle according to the present disclosure.

Various embodiments of the present invention will now be described with reference to the appended drawings. It is to be appreciated that these drawings depict only some embodiments of the invention and are therefore not to be considered limiting of its scope.

### DETAILED DESCRIPTION

Despite the various improvements that have been made to candles, conventional products suffer from some shortcomings as es, discussed above.

There therefore is a need for further improvements to the devices and methods of providing durable keepsake novelty candles. Among other advantages, the present disclosure may address one or more of these needs.

FIG. 1 illustrates a novelty candle 100 extending between a proximal end 102 and a distal end 104. Candle 100 generally includes a durable body 110 having a pattern 112, an upper section having wax 120 and wick 122, and a lower section having a murrini disk 130,a base 132 an optional compartment 140. Details of each of these components will be described with reference to FIGS. 2A-3D.

Candle body 110 is formed by first forming a glass cane 111, such as by glassblowing one or more rods of glass, each rod having one or more colors to form a pattern 112 and twisting or otherwise arranging the rods in a predetermined arrangement. Pattern 112 may be a simple helical or spiral pattern of one color, or complex patterns of multiple colors or rods. There are multiple techniques to form a glass cane. In one technique, a lump of glass having patterns of colored and/or clear glass is heated in a furnace, and pulled to stretch the lump. When cooled and cut, a glass cane 111 is formed as shown in FIG. 2A, the cane having a length of between 2 and 24 inches, and preferably between 2 and 6 inches in length, and a diameter of between 0.05 and 6 inches, and preferably between 0.1 and 1 inch. Alternatively, instead of being handmade a glass cane 111 may be formed through an automated or extrusion process to form the cane in any number of ways as described above. It will be understood that instead of a pattern, a glass can may be clear, or may have one or more colors that are disposed in any shape, location, arrangement or configuration as desired.

Glass cane 111 may further have an image or pattern applied to its inner or outer surfaces, by applying a precious metal thereto. Such precious metals may include silver or gold that is formed in strands, foils or other configurations. In one example, the entire cane of glass cane 111 is heated and rolled across a portion of metallic leaf, such as gold leaf, so that the metal is applied thereto via marvering or other similar techniques. Thus, images, letters, logos, or patterns may be applied to the glass cane 111.

A portion of cane 111 is removed from an upper end to form a candle body 110 having a well 114 or “W” at one end of the cane. Well 114 may be concave and generally bowl-shaped and have a plurality of diameters ranging from a greatest diameter “d1” of between 0.1 and 1 inches, and preferably the diameter “d1” is ¼, ⅓, ½, ⅔, ¾ or more of the diameter of the glass body 110. The diameter may gradually decrease from the distal end 104 toward the proximal end 102 as shown in the cross-section of FIG. 2C. Additionally, body 110 may have a height “h1” and well 114 may be between 0.1 and 0.5 inches in height “h2” which is measured from the top of the cane to the deepest portion of well 114. Well 114 may be formed by heating the cane 111 and shaping the top of the cane to form the well. Alternatively, well 114 may be mechanically formed by grinding, sanding, drilling or using other mechanical means for removing a portion of the top of the cane so as to provide a receptacle for receiving a predetermined amount of wax. It will be understood that in other embodiments, a durable material other than glass may be used to form the body portion of the candle. Such materials may include, for example, a dirt, a metal, a wood, a plastic, or combinations thereof.

Below the newly-formed well 114 is a solid body portion “S” as shown in FIG. 2B. By “solid”, it is meant that the portion of the body does not define a portion of the well at that longitudinal position and that the body is completely filled with glass across its diameter as shown in the cross-section CS1 of FIG. 2D. The size of the well 114 may be varied, but it would be advantageous to have a solid portion that is at least half of the total height “h1” of the body. Alternatively, solid portion may be greater than 50%, 75%, 80% or 90% of the total height “h1” of the body. Thus, the size of solid portion may be selected so that the well 114 is not too large. This is because the well is configured to house a fuel source as will be discussed in greater detail below, and in such cases, after the fuel source is exhausted and the wick used up, the well may fill with dirt and dust making it unsuitable as a keepsake. Thus, providing a functional well size that will not collect dust and dirt is preferable. In at least some examples, the well size is shaped to hold sufficient fuel for the candle to burn for 15 seconds to 5 minutes.

Turning back to FIG. 1, a lump of a wax 120 is disposed within well 114. Wax 120 may be melted and poured into the well so that it is coupled to body 110 within the well 114. Alternatively, a small portion of wax 120 may be formed to the size of the well and the bottom of the portion may slightly heated so that it is coupleable to the well without complete melting of the wax. In at least some examples, wax 120 includes paraffin wax. Alternatively, instead of paraffin wax, another fuel source may be used, such as tallow, beeswax, spermaceti, stearin, microcrystalline wax, polymer and mineral oil gels, and/or plant waxes. Fragrances may be added to the wax or fuel source, if desired.

A candle wick 122 may be embedded in the wax 120. Wick 122 may draw melted wax (or other fuel source) up to a flame so that the liquid fuel vaporizes and/or combusts. The wick may be selected from ones of various diameters, stiffnesses, fire-resistances, and tethering to control the burn rate. In at least some examples, wick 122 is formed of braided cotton 123. Wick 122 may further include a metallic portion 124 (e.g., gold thread) that is twisted around, or disposed at least partially parallel to, or within the braided cotton 123, so that when the cotton 123 of the wick burns out, the metallic portion 124 remains. Metallic portion 124 may be disposed at least partially within the glass body or otherwise coupled thereto via mechanical means or an adhesive. Wick 122 may also be infused with chemicals to modify its burning characteristics, and such chemicals may include ammonium nitrate and/or ammonium sulfate.

Optionally, candle body 110 further includes a compartment 140 as seen in FIG. 1. Compartment 140 may be formed in the shape of a small bubble in the body 110, similar to an “egg timer” having an hourglass configuration. Compartment 140 may be substantially cylindrical like a test-tube disposed within body 110, and the glass body may be clear around the compartment so that the interior of the compartment is visible from the outside. In at least some examples, compartment 140 may house a specimen “S1,” such as sand, soil, a liquid, a memorabilia, or other small items or mediums within the chamber of the compartment. For example, a small amount of sand from a favorite vacation destination or a site of a wedding proposal may be collected and housed within the compartment to commemorate the occasion.

As shown in FIG. 2E and 2F, a candle may be formed in substantially the same manner as that of FIGS. 2A-C, but may include an inner wall 142 to define the hollowed out portion that makes compartment 140 (FIG. 2F). In at least some examples, compartment 140 may have a height “C” as shown in FIG. 2E, the height being proportional to the height of the solid portion “S”. In examples having such a compartment, compartment 140 may have a height that is approximately 25%, 30%, 40%, 50%, 60%, 75% or 85% of the total height “h1” of the candle, the heights of the compartment “C,” the solid portion “S,” and the well “W,” collectively equaling the height h1 of the candle in such cases.

A decorative murrini disk may be added to an end of the candle body 110, opposite the wax 120 and wick 122. Murrini disks may include colorful patterns or images that are formed by cutting a glass cane into thin cross-sections. Each murrini disk 330A-D may have a generally cylindrical shape with a diameter that equal to or smaller than the diameter of the candle body and a height of between 0.02 and 0.1 inches, and include an image or pattern, such as a number 331A symbolizing, for example, a first birthday (FIG. 3A), a letter or initial(s) 331B of a person or event to be celebrated (FIG. 3B), an image or emoji 331C, or a pattern 331D. Murrini disks may also be personalized by having a user send or upload an image and forming the murrini disk to have the user's image.

Murrini disks 130 may thus be placed on the underside of candle body 110. In at least some examples, murrini disk 130 has a diameter that is equal to or smaller than the diameter of body 110. Base 432A in the form of molten glass may be used to house murrini disk 130 and attach it to body 110 (FIG. 4A). In such examples, base 432A may have a curved profile “c1” and may align with sides of body 110 so that the bottom of the candle 100 is smooth without any sharp edges. Base 432A may instead include other clear materials, for example, a glue or epoxy.

Optionally, the candle body 110 and base 432A may be sanded down to create smooth curves along the side and bottom of the candle.

In another variation, shown in FIG. 4B, base 432B may be used to house murrini disk 130, but may have a more bulbous shape, the base 432B being applied and disposed on the candle body 110 so that there is an overlap between the side edge of the body 110 and a portion of the base 432B.

In a third variation, a coupler 435, such as an adhesive, glue or epoxy is used to fasten the murrini disk 130 to body 110, and a base 432C, formed of glass, or other material, is disposed on the murrini disk 130 to protect it (FIG. 4C). Alternatively, a murrini disk 130 may be coupled to the body via coupler 435 without a base (FIG. 4D).

In some embodiments, instead of forming a murrini portion and attaching it to body 110 as described above, a pattern, image, number or letter may be directly applied to the bottom of the body 110 via stamping, embossing, optic molding, or laser engraving. Alternatively, an element such as heat-sensitive paper may be attached to the bottom of body 110. It will be understood that any of the techniques described above with respect to the murrini disks may be applied to the bottom of body 110 and that any of the techniques described herein may be applied to the murrini disks.

In use, candles maybe formed having durable parts as described above, in addition to the wax and wick. After use, or after the wax has been exhausted, the user may keep the durable portions of the candle (e.g., the body, murrini and optional base) as memorabilia to commemorate the occasion. The text or images on the murrini may tie the item to the event to be remembered.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

It will be appreciated that the various dependent claims and the features set forth therein can be combined in different ways than presented in the initial claims. It will also be appreciated that the features described in connection with individual embodiments may be shared with others of the described embodiments.

What is claimed is:

1. A novelty candle comprising:
an elongated cylindrical durable glass body having a first height and a first diameter, the glass body having a first end and a second end and defining a concave well adjacent the first end, and a solid portion extending along at least half of the first height;
a fuel source disposed within the well; and
a wick at least partially disposed within the fuel source.

2. The novelty candle of claim 1, wherein the fuel comprises a paraffin wax.

3. The novelty candle of claim 1, further comprising a murrini coupled to a bottom of the glass body adjacent the second end.

4. The novelty candle of claim 3, further comprising a glass base at least partially covering the murrini and forming a plurality of smooth curvatures with sides of the body.

5. A method of manufacturing a novelty candle comprising:
providing an elongated cylindrical durable glass body having a first height and a first diameter, the glass body having a first end and a second end;
forming a concave well in the glass body adjacent the first end while maintaining a solid portion of the glass body that extends along at least half of the first height;
disposing a fuel source within the well, the fuel source including a paraffin wax; and
at least partially disposing a wick within the fuel source.

6. The method of claim 5, at least partially covering the murrini with a glass base to form a plurality of smooth curvatures with sides of the body.

7. A novelty candle comprising:
an elongated cylindrical durable glass body having a first height and a first diameter, the glass body having a first end and a second end and defining a concave well adjacent the first end, a solid, and a compartment defining a hollowed inner chamber housing a specimen therein;
a fuel source disposed within the well, the fuel source including a paraffin wax;
a wick at least partially disposed within the fuel source;
a murrini coupled to a bottom of the glass body adjacent the second end; and
a glass base at least partially covering the murrini and forming a plurality of smooth curvatures with sides of the body.
